(19) United States
(12) Patent Application Publication
(10) Pub. No.: US 2018/0275766 A1
(43) Pub. Date: Sep. 27, 2018

(54) SYSTEM, METHOD AND APPARATUS FOR PROVIDING A USER INTERFACE

(71) Applicant: MindMaze Holdiing SA, Lausanne (CH)

(72) Inventor: Frederic CONDOLO, Lausanne (CH)

(73) Assignee: MindMaze Holdiing SA

(21) Appl. No.: 15/935,851

(22) Filed: Mar. 26, 2018

Related U.S. Application Data
(60) Provisional application No. 62/476,965, filed on Mar. 27, 2017.

(51) Int. Cl. G06F 3/01; G06F 3/0481; G06F 3/0484

(52) U.S. Cl. CPC G06F 3/017; G06K 9/00335; G06F 3/04842; G06F 3/0481

(57) ABSTRACT

Embodiments of the present disclosure are directed to various systems, methods and apparatuses for performing optical analysis to provide a fluid UI (user interface) for a virtual environment, such as a VR (virtual reality) environment or an AR (augmented reality) environment for example. Optical analysis is performed on visual data obtained from a sensor. Preferably the sensor is attached to a body part of the user, such as for example through a wearable device. The visual data may optionally comprise video data, for example, as a series of frames. Optical analysis is performed on the visual data to determine an indication provided by the user, such as a movement by the user. The determined indication is then matched to a UI function, such as selecting an action to be performed through the UI.

### FIELD OF THE DISCLOSURE

The present disclosure, in at least some embodiments, is directed to systems, methods, and apparatuses for providing a user interface, and in particular for such systems, methods, and apparatuses, for providing a user interface with/for a wearable device.

### BACKGROUND

“Hands-free” VR (virtual reality) apps have become more common thanks to very cheap VR devices such as Google Cardboard. However, these devices allow very limited interactions or means for a user interface, as the user has no physical button to press.

In that case, the classical way to interact with a widget (e.g., select a button) is to gaze at the desired widget for a few seconds. This means current state of the art involves staring and waiting at the same widget until the system “understands” you want to select it. This provides a poor user experience, as the fluidity of interaction is broken, especially when the user wants to browse a vast quantity of items (videos, music, articles, and the like) and needs to wait several seconds to browse from one page to another.

Thus, a need exists for methods, apparatuses, and systems that can dynamically determine the location of a mobile device, dynamically determine the nature of the mobile device's environment, and can efficiently determine actions for the mobile device to take based on the dynamically-determined information.

### SUMMARY OF SOME OF THE EMBODIMENTS

Embodiments of the present disclosure include systems, methods and apparatuses for performing optical analysis in order to provide a fluid UI (user interface) for a virtual environment, such as a VR (virtual reality) environment or an AR (augmented reality) environment for example. Optical analysis is performed on movement data obtained from a sensor. Preferably the sensor is attached to a body part of the user, such as for example through a wearable device. The data may optionally comprise visual data or inertial data. The visual data may optionally comprise video data, for example, as a series of frames. If visual data is captured, the sensor may be implemented as a camera, for example as an RGB, color, grayscale or infrared camera, a charged coupled device (CCD), a CMOS sensor, a depth sensor, and/or the like. Optical analysis is performed on the visual data to determine an indication provided by the user, such as a movement by the user. The determined indication is then matched to a UI function, such as selecting an action to be performed through the UI.

Non-limiting examples of optical analysis algorithms include differential methods for optical flow estimation, phase correlation, block-based methods for optical flow estimation, discrete optimization methods, simultaneous localization and mapping (SLAM) or any type of 6 DOF (degrees of freedom) algorithm. Differential methods for optical flow estimation include but are not limited to Lucas-Kanade method, Horn-Schunck method, Buxton-Buxton method, Black-Jepson method and derivations or combinations thereof.

According to some non-limiting embodiments, tracking of the movement of the user's head or other body part can be performed through SLAM (“Simultaneous Localization and Mapping”). SLAM was initially applied to problems of independent movement of a mobile robot (device). In some such systems, the location of the mobile device (e.g., robot) is necessary—that is, its location on a map of an environment, as is a map the environment, so that the mobile device can determine its relative location within that environment. In some known systems, however, these tasks cannot be performed simultaneously, which results in substantial delays when processing mobile device location information.

SLAM can be performed with sensor data from a number of different sensor types. Visual SLAM refers to the use of visual data from a visual sensor, such as for example a camera, to perform the SLAM process. In some cases, only such visual data is used for the SLAM process (see, for example, Fuentes-Pacheco et al., “Visual Simultaneous Localization and Mapping: A Survey,” Artificial Intelligence Review 43(1), November 2015).

Various types of sensors and the use of their data in the SLAM process are described in C. Cadena et al., “Past, Present, and Future of Simultaneous Localization and Mapping: Toward the Robust-Perception Age,” in IEEE Transactions on Robotics, vol. 32, no. 6, pp. 1309-1332, Dec. 2016. (available at https://arxiv.org/pdf/1606.05830.pdf). This article also describes the importance of the “pose,” or position and orientation, for the SLAM process. The pose relates to the position and orientation of the robot or other entity to which the sensor is attached, while the map describes the environment for that robot.

Additionally, some known systems cannot dynamically determine the nature of the mobile device's environment, and therefore, cannot dynamically determine navigation instructions, and/or other information. For example, in some known systems, a navigator for the mobile device can input pre-determined environment data into the known system to provide a description of the environment. Such known systems, however, cannot modify the description of the environment substantially in real-time, based on new environmental information, and/or the like.

In some embodiments, an optical-based UI system is provided for a wearable device, including without limitation, a head-mounted wearable device that optionally includes a display screen. Such systems, methods and apparatuses can be configured to accurately (and in some embodiments, quickly) determine a motion of the wearable device, e.g., through computations performed with a computational device. A non-limiting example of such a computational device is a smart cellular phone or other mobile computational device. Such a motion may then be correlated to a UI function, for example by allowing the user to make a selection with a relevant motion of the wearable device.

If inertial measurements are used, they may be provided through an IMU (inertial measurement unit), and/or other sensors. If the sensor is implemented as an IMU, the sensor can be an accelerometer, a gyroscope, a magnetometer, and/or the like. One drawback of an IMU is its poor ability to track the position of an object over time because of drift. That is, an IMU can detect the motion and acceleration of an object quite well, but not slow or subtle movements nor the precise position of an object.

Optionally a combination of inertial measurements and visual data may be used, for example by having an IMU and a camera.

Unless otherwise defined, all technical and scientific terms used herein have the same meaning as commonly understood by one of ordinary skill in the art to which this disclosure belongs. The materials, methods, and examples provided herein are illustrative only and not intended to be limiting.

Various embodiments of the methods, systems and apparatuses of the present disclosure can be implemented by hardware and/or by software or a combination thereof. For example, as hardware, selected steps of methodology according to some embodiments can be implemented as a chip and/or a circuit. As software, selected steps of the methodology (e.g., according to some embodiments of the disclosure) can be implemented as a plurality of software instructions being executed by a computer (e.g., using any suitable operating system). Accordingly, in some embodiments, selected steps of methods, systems and/or apparatuses of the present disclosure can be performed by a processor (e.g., executing an application and/or a plurality of instructions).

Although embodiments of the present disclosure are described with regard to a “computer”, and/or with respect to a “computer network,” it should be noted that optionally any device featuring a processor and the ability to execute one or more instructions is within the scope of the disclosure, such as may be referred to herein as simply a computer or a computational device and which includes (but not limited to) any type of personal computer (PC), a server, a cellular telephone, an IP telephone, a smartphone or other type of mobile computational device, a PDA (personal digital assistant), a thin client, a smartwatch, head mounted display or other wearable that is able to communicate wired or wirelessly with a local or remote device. To this end, any two or more of such devices in communication with each other may comprise a “computer network.”

### BRIEF DESCRIPTION OF THE DRAWINGS

Embodiments of the disclosure are herein described, by way of example only, with reference to the accompanying drawings. With specific reference now to the drawings in detail, it is stressed that particulars shown are by way of example and for purposes of illustrative discussion of the various embodiments of the present disclosure only and are presented in order to provide what is believed to be a useful and readily understood description of the principles and conceptual aspects of the various embodiments of inventions disclosed therein.

FIG. 1A shows schematic of a non-limiting example of a UI system for a virtual environment, according to at least some embodiments;

FIG. 1B shows a schematic of a non-limiting example of a method for operating a UI system for a virtual environment, according to at least some embodiments;

FIG. 2 shows a schematic of a non-limiting example of an optical data analyzer according to at least some embodiments;

FIG. 3 shows a schematic of another non-limiting example of a system according to at least some embodiments;

FIGS. 4A and 4B show an exemplary schematic diagram of how the UI system may operate from the perspective of the user, while FIG. 4C provides an exemplary method for such operation, according to at least some embodiments of the present invention, and FIG. 4D shows an exemplary screen which makes it easier for a user to browse and select from a plurality of items, such as a plurality of media items for example; and

FIGS. 5A-5C show exemplary screenshots from the display that the user would view, from the perspective of the user.

FIGS. 6 and 7 illustrate non-limiting examples of a methods for interacting with a fluid UI.

FIG. 8 illustrates a non-limiting, exemplary schematic of fuzzy logic that can be applied to movements and poses in preferred embodiments.

FIG. 9 illustrates a non-limiting example of a method for error correction of movements and poses in preferred embodiments.

### DETAILED DESCRIPTION OF SOME OF THE EMBODIMENTS

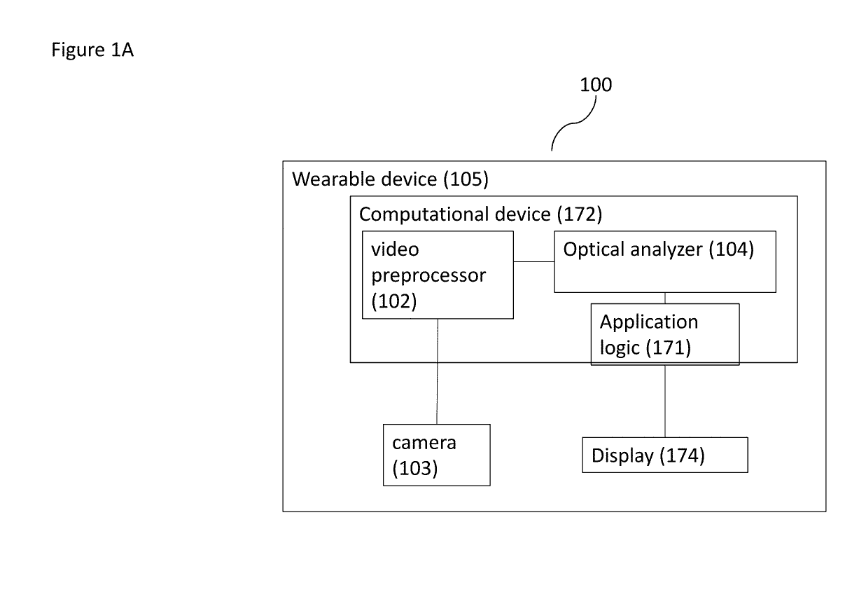

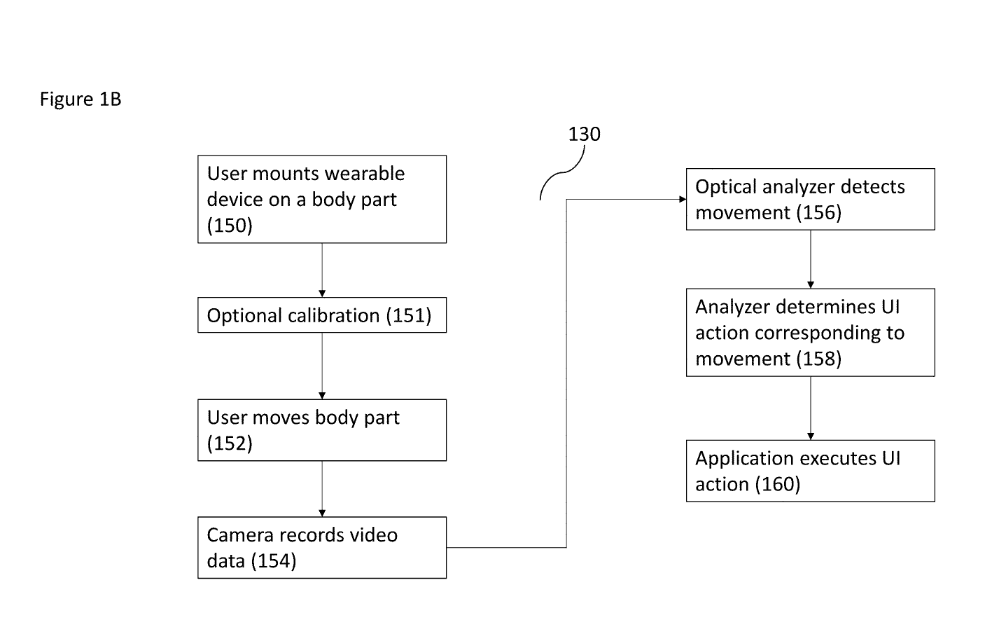

FIG. 1A shows a schematic of a non-limiting example of a UI system for a virtual environment, according to at least some embodiments of the present disclosure. In some implementations, UI system 100 can include at least one computational device 172 (as indicated earlier, the terms/phrases of computer, processor, and computational device can be used interchangeably in the present disclosure), a wearable device 105, and a camera 103 as a non-limiting example of a sensor for collecting movement data, in this example as visual data. Camera 103 may optionally be a video camera, for example. The computational device 172 can include a video preprocessor 102 and an optical analyzer 104 and can be operatively coupled to the wearable device 105 (e.g., wired or wirelessly), and can be included in the wearable device 105, and/or some combination thereof. Video preprocessor 102 and optical analyzer 104 can be separate processors in and of themselves in the computational device 172, or, may be software modules (e.g., an application program and/or a set of computer instructions for performing optical analysis functionality operational on one or more processors). In some implementations, the computational device 172 can be configured to receive signal data (e.g., from the wearable device 105), to preprocess the signal data, to determine movement of the wearable device, and to instruct the wearable device to perform one or more actions based on the movement of the wearable device. Specifically, in some implementations, video preprocessor 102 can receive sensor data, in this case visual data or image data, from the wearable device 105 and can perform preprocessing on the sensor data. For example, video preprocessor 102 can generate abstracted sensor data based on the sensor data. The terms “sensor data,” “visual data,” “image data,” and other terms used to reference data that is received from a sensor, such as a camera or IMU, should be understood as referencing the data output by the particular type of sensor discussed or, where different types of sensors are being discussed generally, as referencing the different types of data output by the different types of sensors applicable to the discussion.

In accordance with preferred embodiments, wearable device 105 can itself be a mobile computational device or computational device 172 can be a mobile computational device. In some preferred embodiments camera 103 can be the camera of a mobile computational device.

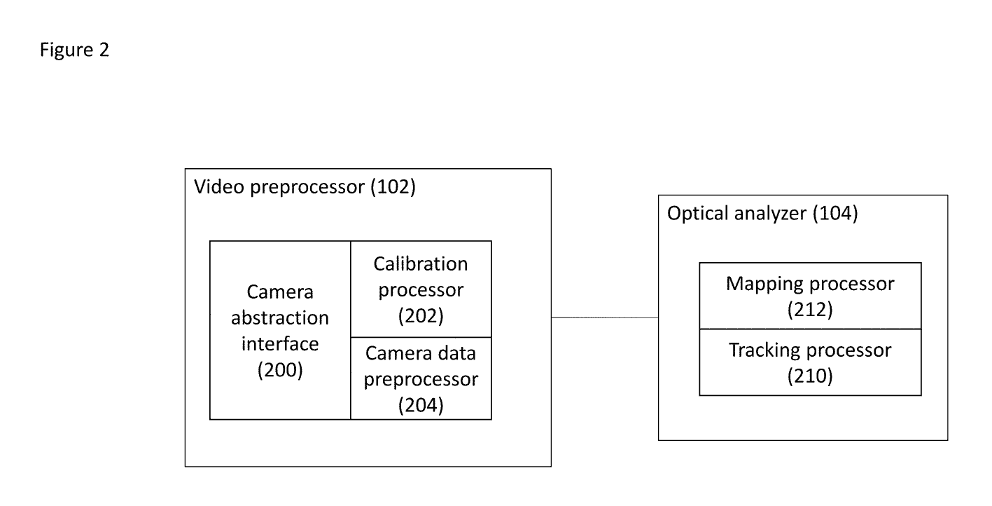

In accordance with some preferred embodiments, optical analyzer 104 is configured to operate an optical analysis process to determine a location of wearable device 105 within a computational device-generated map, as well as being configured to determine a map of the environment surrounding wearable device 105. For example, optical analyzer 104 In accordance with other preferred embodiments, optical analyzer 104 is configured to operate an optical analysis process to determine movement of a wearable device 105 across a plurality of sets of image data and not within a map of the environment in which wearable device 105 is moving. For example, as described in further detail below in connection with FIGS. 1B and 2, the optical analysis process can be used to translate data related to movement of the user's head, some other body part, or combinations of body parts when wearing the wearable device (e.g., on the user's head or body). A wearable that is worn on the user's head would for example provide movement information with regard to turning the head from side to side, or up and down, moving the body in a variety of different ways, or a combination thereof. Such movement information is needed for optical analysis to be performed. As discussed in further detail below, data related to a static pose following movement (and therefore also related to movement) can be provided for optical analysis as well.

In some implementations, because the preprocessed sensor data is abstracted from the specific sensor(s) (e.g., one or more cameras or types of cameras), the optical analyzer 104, therefore, can be sensor-agnostic, and can perform various actions without knowledge of the particular sensors from which the sensor data was derived.

As a non-limiting example, camera 103 can be a digital camera including a resolution, for example, of 640×480 and greater, at any frame rate including, for example 60 fps, such that movement information may be determined by optical analyzer 104 according to a plurality of images from the camera. For such an example, video preprocessor 102 preprocesses the images before optical analyzer 104 performed the analysis. Such preprocessing can include converting images to grayscale or some other color reduction technique, image compression or size reduction, or some other technique to reduce the payload on the processing. In some embodiments, preprocessing can include computing a Gaussian pyramid for one or more images, which is also known as a MIPMAP (multum in parvo map), in which the pyramid starts with a full resolution image, and the image is operated on multiple times, such that each time, the image is half the size and half the resolution of the previous operation. In a preferred embodiment a 2- or 3-level Gaussian pyramid is generated.

Optical analyzer 104 receives image data that may or may not be preprocessed to determine motion in the image. Optical analyzer 104 may perform a wide variety of different variations on various optical analysis algorithms, including but not limited to differential methods for optical flow estimation, phase correlation, block-based methods for optical flow estimation, discrete optimization methods, simultaneous localization and mapping (SLAM) or any type of 6 DOF (degrees of freedom) algorithm. Differential methods for optical flow estimation include but are not limited to Lucas-Kanade method, Horn-Schunck method, Buxton-Buxton method, Black-Jepson method and derivations or combinations thereof. It should be understood that the above differential methods for optical flow estimation include the methods listed as well as their derivatives.

Skilled artisans can appreciate that each of the above methods can be used to determine whether a series of images shows movement of a user and the type of movement or movement in the environment of a user and the type of movement. In particular, the skilled artisan can appreciate that some optical analysis methods work well for large movements but not minor movements. Thus, to the extent the UI interactions correlate to minor body movements (e.g., head nod, hand movement with a stationary arm, etc.) either alone or in combination with larger body movements (e.g., shoulder or body lean, arm raise, etc.), embodiments that use, for example, Lucas-Kincade (which prefers small motions) either alone or in combination with, for example, Horn-Schunk (which is sensitive to noise in the images and thus, is preferable for larger movements) can be more suitable. Likewise, where UI interactions correlate to larger body movements only, algorithms best applicable to recognizing larger displacements within an image can be more suitable. Embodiments including SLAM preferably include no other optical analysis methods because of the computational cost, while embodiments that implement a differential method for optical flow estimation can include preferably no more than two method types.

In other embodiments, an IMU (inertial measurement unit) can be included to help detect movement. In yet other embodiments, an IMU can be used in lieu of optical analysis. In embodiments including an IMU, sensor data related to the movement inertia of a user is received by computational device 172. Embodiments using an IMU are limited in the types of movements that can be correlated to a UI object or action given that an IMU will detect movement and the cessation of movement but not a static pose. For example, in some embodiments, a user can lean a shoulder to the right or left and hold the lean to communicate to the UI a scrolling action to the right or left, respectively. An IMU can have difficulty detecting position over time because of drift. Thus, preferred embodiments in which UI interactions correlate to positions or static poses of the user, a sensor that captures visual or image data is useful either alone or in combination with an IMU. Furthermore, it should be understood that embodiments that rely on sensor data only from an IMU or non-visual sensor data would not require optical analyzer 104.

In preferred embodiments, optical analyzer 104 can detect static poses of a user. In other words, optical analyzer 104 can detect in image data the movement of an identified body or body part to a position and that the position of the body or body part remains in the position (i.e., does not move again out of the position). For example, optical analyzer 104 can detect a shoulder lean movement where the user holds the lean. A static pose with which the user can interact with the UI can include any static pose at the end of a movement. For example, a static pose can include a shoulder lean, holding an arm in a certain position, tilting the head up, down, or to the side, and the like. A static pose is a continuation and culmination of a movement gesture that operates in conjunction with the movement to communicate a UI action. In accordance with preferred embodiment, a UI interaction can be correlated to the movement and the static pose together; a first UI interaction can be correlated to the movement and a second UI interaction to continue the first UI interaction can be correlated to the static pose; or a first UI interaction can be correlated to the movement and a second UI interaction to cease the first UI interaction can be correlated to a movement away from the static pose.

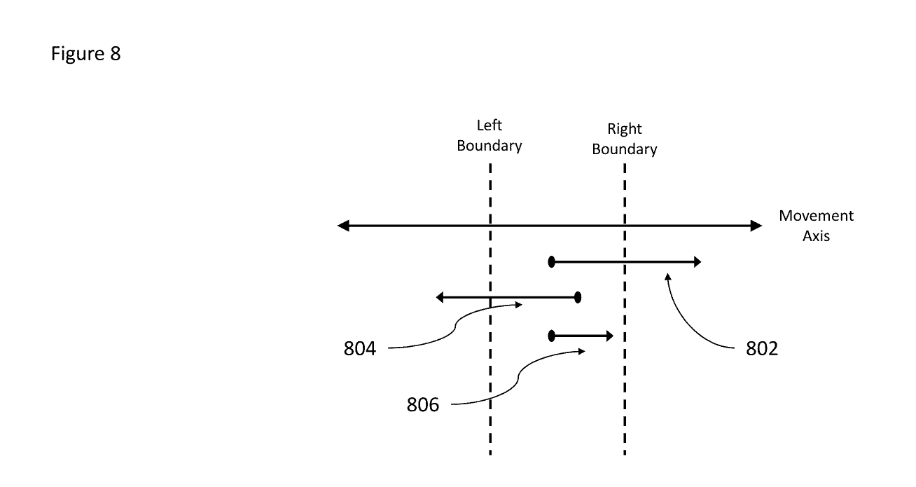

Static poses can be difficult for some users to hold or to hold steady in such a way as to maintain the UI activity. For example, a scroll through a list using a shoulder lean can be disrupted if the user fails to hold still during the lean or to maintain the lean far enough. Preferred embodiments to maintain a scroll through a list can use fuzzy logic (discussed below in connection with FIG. 8) to discount minor movements during the course of the UI activity. Fuzzy logic can likewise be applied to determine whether a user intended a movement or not by requiring movement beyond a threshold.

In accordance with preferred embodiments, optical analyzer 104 is not limited to detecting movements within image data that are correlated only to instructions to interact with an already-selected UI object. Optical analyzer 104 can also detect a movement within image data where the movement is correlated to an instruction to activate a UI object. In some embodiments, correlating a movement to UI object activation can be done by itself or in conjunction with the classical gaze technique for UI object activation. In such embodiments, the position of a reticle or cursor over an object during a movement can trigger activation. In yet other embodiments, the position of a body part during movement of the body part against a computer-generated image map can be translated to the UI so that an object in the UI that has a position that corresponds to the position of the body part can be activated. In embodiments that correlate a movement within image data to the activation of a UI object, again it is preferable to apply fuzzy logic to avoid accidental.

Still referring to FIG. 1A, optionally, optical analyzer 104 can perform variations on the SLAM process, including one or more of, but not limited to, PTAM (Parallel Tracking and Mapping), as described for example in Klein and Murray, “Parallel Tracking and Mapping on a Camera Phone,” Proceedings of the 2009 8th IEEE Int'l Symposium on Mixed and Augmented Reality, 2009; DSO (Direct Sparse Odometry), as described, for example, in Engel et al., “Direct Sparse Odometry,” 2016 (available at https://arxiv.org/abs/1607.02565); or any other suitable SLAM method, including those as described herein.

In some implementations, the wearable device 105 can be operatively coupled to the camera 103 and the computational device 172 (e.g., wired, wirelessly). The wearable device 105 can be a device (such as an augmented reality (AR) and/or virtual reality (VR) headset, and/or the like) configured to receive sensor data, so as to track a user's movement when the user is wearing the wearable device 105. It should be understood that embodiments of the present invention are not limited to headset wearable devices and that wearable device 105 can be attached to another part of the body, such as the hand, wrist, torso, and the like such that movements by other parts of the body are used to interact with the UI. The wearable device 105 can be configured to send sensor data from the camera 103 to the computational device 172, such that the computational device 172 can process the sensor data to identify and/or contextualize the detected user movement.

In some implementations, the camera 103 can be included in wearable device 105 and/or separate from wearable device 105. In embodiments including a camera 103 included in wearable device 105, optical analysis can be performed on the visual data of the user's environment to determine the user's movement. In embodiments including a camera 103 separate from wearable device 105, optical analysis can be performed on visual data of the user or a portion of the user's body to determine the user's movement. Camera 103 can be a video camera or still-frame camera and can be one of an RGB, color, grayscale or infrared camera or some other sensor that uses technology to capture image data such as a charge-coupled device (CCD), a CMOS sensor, a depth sensor, and the like.

FIG. 1B shows a schematic of a non-limiting example of a method for operating a UI system for a virtual environment, according to at least some embodiments. As shown in a method 130, at step 150 the user mounts wearable device on a body part, such as a head mounted device for example, which features a camera. Some preferred embodiments do not require a wearable device and, instead, rely on sensor data generated by a sensor not attached to the user and not requiring a wearable device on the user to track the user. For example, some embodiments may track user movement using one or more cameras and optical flow methods appropriate to the camera(s) and UI requirements to determine user movement.

At step 151, optionally a calibration step is performed. Preferably, such a calibration step is performed in some embodiments using optical flow methods which do not feature 6 DOF. For other types of optical flow methods, a calibration step is optionally and preferably performed for greater accuracy of determining movements of the user. For example, SLAM in 3D does feature 6 DOF which means that, in some preferred embodiments, no calibration is performed. Calibration is discussed further below in connection FIG. 2.

At step 152, the user moves the body part on which the wearable device is mounted, for example by moving the user's head, shoulders, arm, etc. At step 154, the camera records visual data, such as video data for example.

At step 156, the optical analyzer detects movement of the user's body part, such as the user's head, shoulders, arm, etc., according to movement of the wearable device within the user's environment, by analyzing the visual data of the environment. The optical analyzer may optionally perform such analysis according to any of the above optical algorithms. Again, for embodiments in which camera 103 is separate from wearable device 105, the optical analyzer detects movement of the user's body part according to movement of the user's body part.

At step 158, the optical analyzer determines which UI action corresponding to movement has been selected by the user. For example, as described in greater detail below, a movement of the user's head or shoulders could optionally be related to a UI action of scrolling through a plurality of choices in the UI. Such choices could be visually or audibly displayed to the user. A different movement of the user's head could relate to selecting one of the choices. For some UI interactions, the interaction can be continuous (e.g., scrolling through images or a list). In preferred embodiments, the optical analyzer detects that the user has moved from a first position to a second position and as the user remains in the second position, the continuous interaction remains active (e.g., scrolling continues). In such embodiments, the optical analyzer determines whether the user has moved back or near to the first position or to a third position which can indicate an instruction to cease the continuous interaction (e.g., cease scrolling). In other words, in preferred embodiments, the user need not make another, distinct gesture to further interact with the UI. Instead, the user can maintain a static pose to interact with the UI and when the user moves, for example, back to the original position, the interaction can cease. The optical analyzer can ascertain the speed of the user's movement to a second position and determine a quality of the UI interaction (e.g., faster user movement=faster scrolling). In yet other embodiments, the optical analyzer can determine a quality of the UI interaction like scrolling speed by further movement in the same direction. For example, if the optical analyzer determines that the user has leaned right which correlates to a scroll to the right command, the optical analyzer can then determine whether the user leans more to the right which can correlate to faster scrolling. It should be understood that preferred embodiments can use other types of UI interaction in conjunction with the movement-based interaction such as audible or tactile (e.g., mouse, keyboard, etc.).

If the choices are provided audibly, for example by announcing a name or title of a choice, then the UI system would not be limited to a virtual environment, or at least not to such a virtual environment that is based solely or mainly on display of visual information.

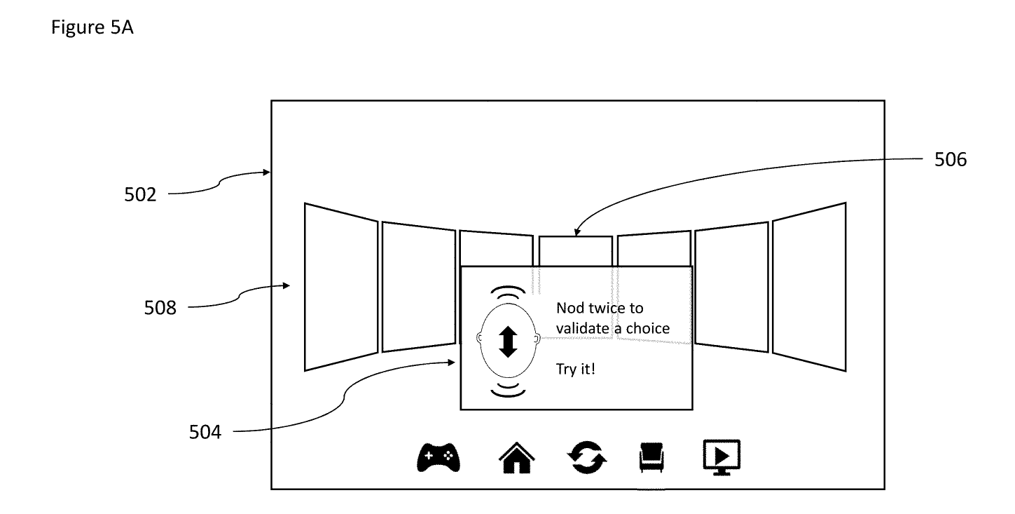

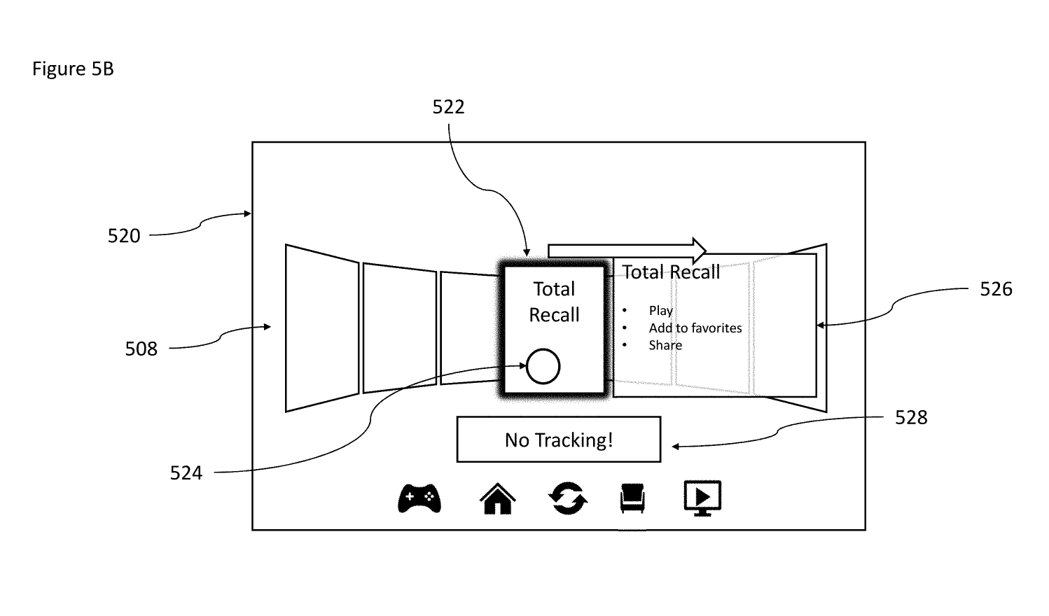

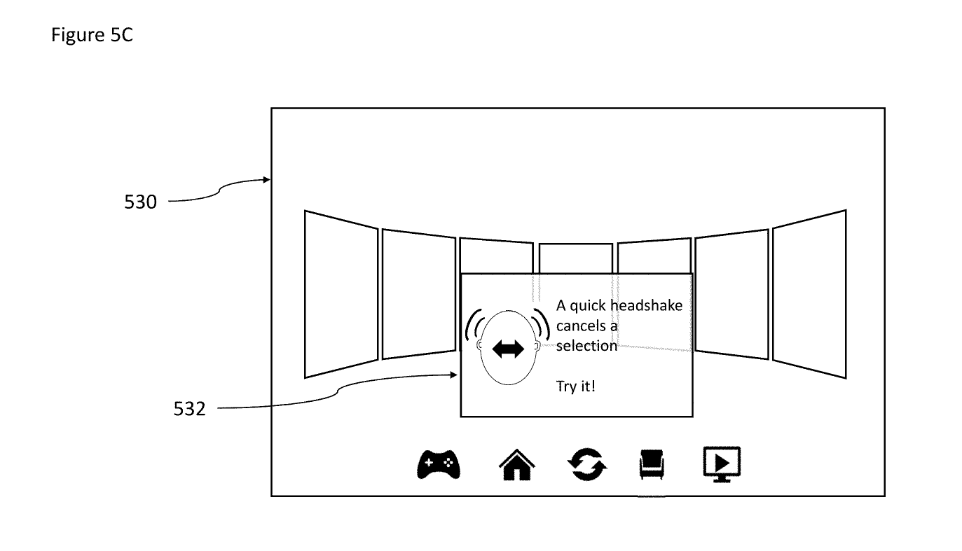

At step 160, the application that supports the UI would execute a UI action, based upon determining which UI action corresponds to which movement. In preferred embodiments, an optical analyzer will assign a classification to a movement and the system will have a data store that maintains a correlation between a UI interaction and the movement classification. The particular classifications of movement and correlations can depend on the nature and complexity of the UI as well as the type of sensors used (e.g., mounted on a wearable and directed at the environment vs. directed at the user, type and number of wearables on which sensors are mounted, etc.) In one preferred embodiment, as shown in FIGS. 5A-5C, the UI presents a series of simple UI objects for selection and simple popup menus. Thus, a limited number of large user movements (e.g., leans and head nods) can be used to interact with and select objects. By using a limited number of large user movements, the system can be more easily adjustable to use a sensor mounted on a wearable device or external to the user and to use fewer and less sophisticated sensors.

FIG. 2 shows a schematic of a non-limiting example of an optical data analyzer 104 and video preprocessor 102 according to at least some embodiments. As shown, video preprocessor 102 can include a camera abstraction interface 200, a calibration processor 202 and a camera data preprocessor 204. Camera abstraction interface 200 can abstract the incoming camera data (for example, abstract incoming camera data from a plurality of different camera types), such that video preprocessor 102 can receive camera-agnostic camera data for preprocessing.

In some implementations, calibration processor 202 can be configured to calibrate the camera input, such that the input from individual cameras and/or from different types of cameras can be calibrated. As an example of the latter, if a camera's type and/or model is known and has been analyzed in advance, calibration processor 202 can be configured to provide the camera abstraction interface 200 with information about device type calibration requirements (for example), so that the camera abstraction interface 200 can abstract the data correctly and in a calibrated manner. For example, the calibration processor 202 can be configured to include information for calibrating known makes and models of cameras, and/or the like. Skilled artisans can appreciate that calibration can be necessary for different types or models of cameras because of differing types and levels of distortion and the like from different types or models of cameras. Calibration processor 202 can also be configured to perform a calibration process to calibrate each individual camera separately, e.g., at the start of a session (upon a new use, turning on the system, and the like) using that camera. The user (not shown), for example, can take one or more actions as part of the calibration process, including but not limited to displaying printed material on which a pattern is present. The calibration processor 202 can receive the input from the camera(s) as part of an individual camera calibration, such that calibration processor 202 can use this input data to calibrate the camera input for each individual camera. The calibration processor 202 can then send the calibrated data from camera abstraction interface 200 to camera data preprocessor 204, which can be configured to perform data preprocessing on the calibrated data, including but not limited to reducing and/or eliminating noise in the calibrated data, normalizing incoming signals, and/or the like. The video preprocessor 102 can then send the preprocessed camera data to an optical analyzer 104.

Optical analyzer 104, according to at least some embodiments, may include a tracking processor 210 and a mapping processor 212. Optionally, only tracking processor 210 is featured, depending upon the type of optical algorithm performed. For example, for some types of optical algorithms, only tracking of the user's movements through the wearable device would be needed and/or performed, such that optionally only tracking processor 210 is featured. For other types of optical algorithms, in addition to tracking, the relative location of the movement of the wearable device on a map that corresponds to the UI would also be determined; for such embodiments, mapping processor 212 is also included. Optionally a localization processor is also included (for example, for SLAM implementations).

In some implementations, the mapping processor 212 can be configured to create and update a map of an environment surrounding the wearable device (not shown). Mapping processor 212, for example, can be configured to determine the geometry and/or appearance of the environment, e.g., based on analyzing the preprocessed sensor data received from the video preprocessor 102. Mapping processor 212 can also be configured to generate a map of the environment based on the analysis of the preprocessed data. In some implementations, the mapping processor 212 can be configured to send the map to the localization processor 206 to determine a location of the wearable device within the generated map.

Tracking processor 210 would then track the location of wearable device on the map generated by mapping processor 212.

In some implementations, tracking processor 210 can determine the current location of the wearable device 105 according to the last known location of the device on the map and input information from one or more sensor(s), so as to track the movement of the wearable device 105. Tracking processor 210 can use algorithms such as a Kalman filter, or an extended Kalman filter, to account for the probabilistic uncertainty in the sensor data.

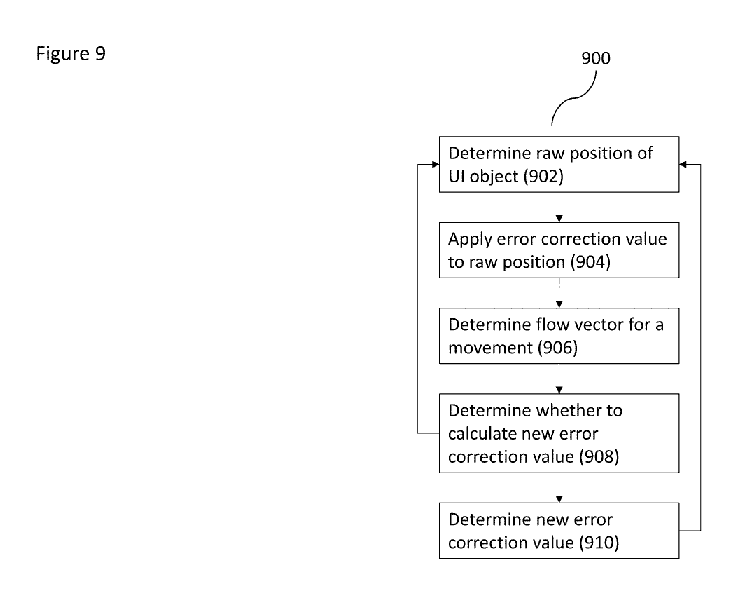

In some implementations, the tracking processor 210 can track the wearable device 105 in a way so as to reduce jitter. In other words, a UI cursor or a UI interaction (e.g., scrolling) can track so closely to a user's movement that if the user's velocity frequently changes over the course of a larger movement, the UI can reflect each sudden change thus causing some disorientation to the user. For example, when a user moves an arm up in interaction with the UI, the user can have a shoulder muscle twitch or can struggle raising the arm past horizontal smoothly so that there are sudden movements of the arm from side to side or hitches during the movement. Because the user will not move smoothly or because of the potential for lag in the tracking, a direct correlation of a UI object movement and the user movement may result in jitter (i.e., non-fluid movement of the UI object). To alleviate such jitter, the tracking processor 210 could estimate an error of movement at each step of the process to modulate the mapping process results. However, such processing can be computationally intensive given its frequency. Therefore, preferred embodiments can determine an estimated error value or constant to modulate the results of the optical analysis and the mapping process and use this error value over multiple periods of the process which is discussed further in connection with FIG. 9.

In some implementations, the output of tracking processor 210 can be sent to mapping processor 212, and the output of mapping processor 212 can be sent to tracking processor 210, so that the determination by each of the location of the wearable device 105 and the map of the surrounding environment can inform the determination of the other.

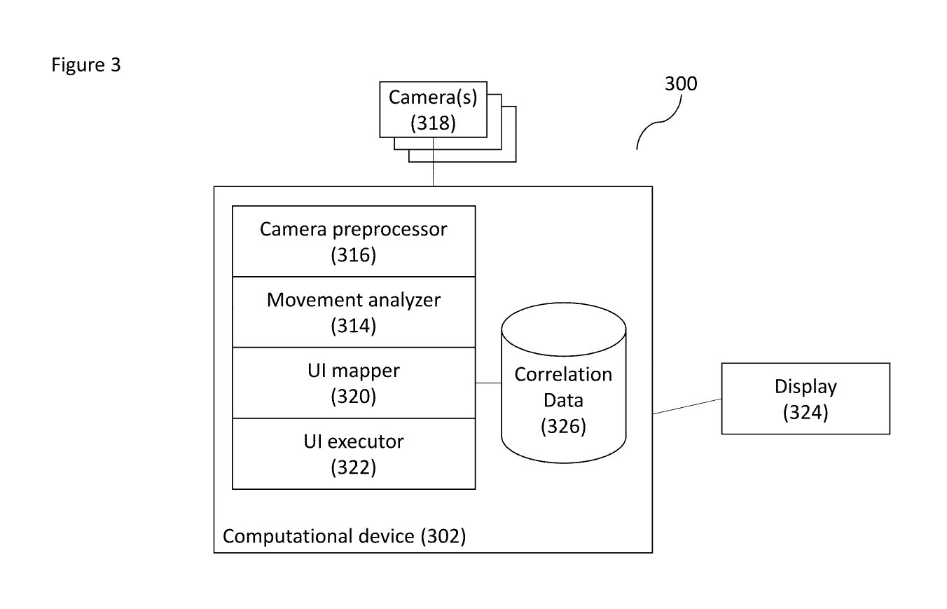

FIG. 3 shows a schematic of another non-limiting example system according to at least some embodiments of the present invention, relating to one or more cameras communicating with a computational device, shown as a system 300. As shown, system 300 includes a computational device 302 in communication with one or more cameras 318. Camera(s) 318 may comprise any type of camera as described in the present disclosure, or a plurality of different types of cameras.

Computational device 302 preferably operates a camera preprocessor 316, which may optionally operate as previously described for other camera preprocessors. Preferably, camera preprocessor 316 receives input data from one or more cameras 318 and processes the input data to a form which is suitable for use by movement analyzer 314. Movement analyzer 314 may operate as previously described for other optical analyzers.

Movement analyzer 314 is preferably in contact with a UI mapper 320, which correlates each movement determined by movement analyzer 314 with a particular UI function or action. UI mapper 320 can include a repository of UI function or actions with identifiers of the movements to which they correlate. In some embodiments, UI mapper 320 can be customized by a user. For example, a user may have difficulty with a particular movement or gesture that is correlated to a UI function or action. In that case, the user may adjust UI mapper 320 so that a modified movement or gesture or a different movement or gesture is correlated to the UI function or action. Correlation data store 326 can be used to maintain correlations of UI functions and movement information. The movement information can be an identifier of classification of movement or of a specific movement as generated by movement analyzer 314 (or optical analyzer 104 from FIGS. 1A and 2). In some embodiments, data store 326 can be a memory or drive component of computational device 302. In yet other embodiments, data store 326 can be a memory or drive outside of computational device 302 and in communication with UI mapper 320. The function or action to be performed through or with the UI is then performed by UI executer 322. Any changes to a display shown to the user would be made through a display 324.

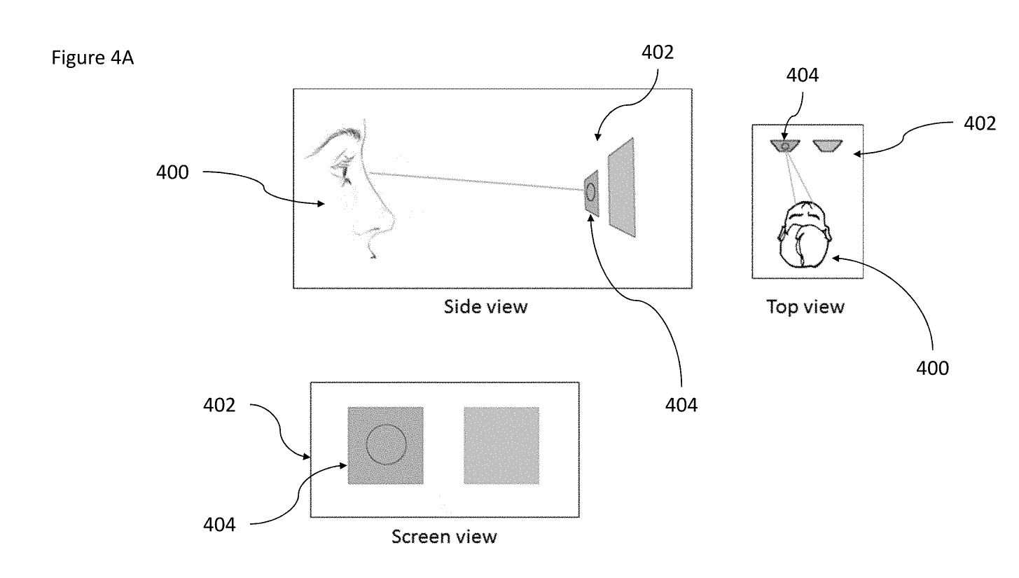

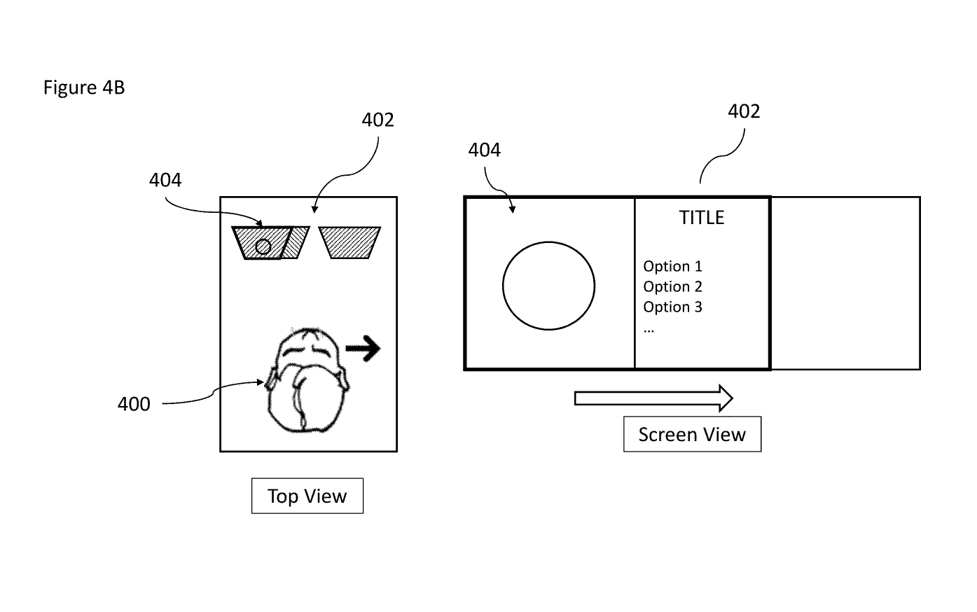

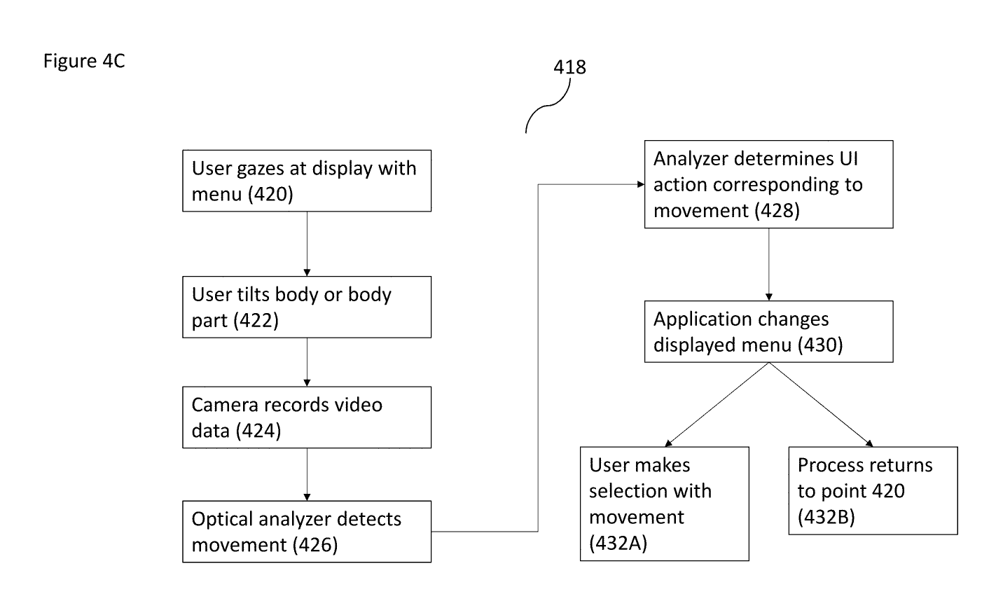

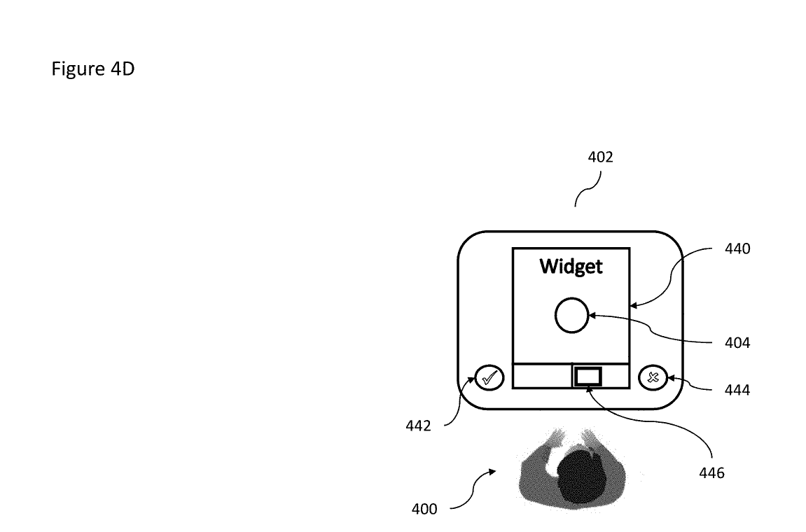

FIGS. 4A and 4B show an exemplary schematic diagram of how the UI system may operate from the perspective of the user, while FIG. 4C provides an exemplary method for such operation, according to at least some embodiments of the present invention.

As shown in FIGS. 4A and 4B, a user 400 triggers an event comparable to a right click.

First, the user 400 places the cursor (here, a red circle, shown as 404) on top of the desired item using the classical gaze system, by gazing at the desired item in a display 402. In preferred embodiments the user can invoke a gesture to activate a cursor 404 in display 402. For example, the user can invoke a gesture (e.g., head nod, head title, arm raise, etc.) to activate a cursor and invoke a second gesture (e.g., tilt head to the left, lean body to the left, swipe arm to the left, etc.) to move the cursor over the item. Skilled artisans can appreciate that different gestures or movements can be used to activate and interact with UI objects. Side, top and screen views are shown in FIG. 4A.

Turning now to FIG. 4B, the user 400 leans toward one side, and/or tilts his/her head to one side, to open a contextual menu shown in display 402, related to the selected item 404. The direction of tilting or leaning is shown by the arrow in the top view diagram. Gestures or movements other than a lean or head tilt could be captured by a camera and translated into a UI instruction.

FIG. 4C provides an exemplary method for operation of a UI system from the perspective of the user, according to at least some embodiments of the present invention. As shown in a method 418, at step 420, the user gazes at a menu displayed on a display, for example a head mounted display as part of a wearable. At step 422, the user tilts the user's body or body part. As discussed above in connection with previous figures, other movements could also be performed. For embodiments which include a wearable device on which a camera is mounted or otherwise operate through optical analysis of the user's environment absent optical analysis of images of the user's body, such tilting preferably results in movement of the body part on which the wearable device is mounted, for example by moving the user's head if the wearable device is head-mounted. At step 424, the camera records visual data, such as video data for example, while the user is moving.

At step 426, the optical analyzer detects movement of the user's body part, such as the user's head, according to movement of the wearable device, by analyzing the visual data. The optical analyzer may optionally perform such analysis according to any of the above optical algorithms. At step 428, the optical analyzer determines which UI action corresponding to movement has been selected by the user. For example, as described in greater detail below, a movement of the user's head could optionally be related to a UI action of scrolling through a plurality of choices in the UI. Such choices could be visually or audibly displayed to the user. A different movement of the user's head could relate to selecting one of the choices.

If the choices are provided audibly, for example by announcing a name or title of a choice, then the UI system would not be limited to a virtual environment, or at least not to such a virtual environment that is based solely or mainly on display of visual information.

At step 430, the application that supports the UI causes a new menu to be displayed, the display of the new menu being the UI action that is performed in response to a particular movement or set of movements. Then the method optionally continues as follows: at step 432A, the user selects a menu item, preferably with some type of movement or combination of movements. In other words, the camera records another movement, similar to step 424; the optical analyzer detects the movement in the image data received from the camera, similar to step 426; and the analyzer determines that a selection UI action corresponding to the movement, similar to step 428. Alternatively, the process returns to step 420 if the user does not make such a selection, that is, the analyzer determines that no relevant movement by the user is indicated in image data received from a camera (for example, in order to see more selections from the menu).

FIG. 4D shows an exemplary screen which makes it easier for a user to browse and select from a plurality of items, such as a plurality of media items for example. As shown, user 400 gazes at a widget 440, thereby placing a cursor 404 on widget 440. As discussed above in connection with FIG. 4A, in preferred embodiments, a movement or gesture, rather than a gaze, from user 400 can activate cursor 400 on widget 440. In yet other embodiments, a second movement or gesture from user 400 can place cursor 400 on widget 440 after activating cursor 400. If the user 400 wishes to open or otherwise invoke some action through widget 440, the user 400 can lean to the right, to move a user view gauge 446 to a position 442. If the user 400 wishes to close widget 440, the user 400 can lean to the left, to move user view gauge 446 to a position 444. Similarly, to browse through a series of items, for example when cursor 404 is placed at a scrolling menu bar, the user 400 can lean to the left, to move user view gauge 446 to position 444, and the menu will scroll to the left. If the user 400 leans to the right, to move user view gauge 446 to position 442, the menu will scroll to the right.

FIGS. 5A-5C show exemplary screenshots from the display that the user would view, from the perspective of the user. FIG. 5A shows an exemplary screenshot 502, in which a message 504 appears to encourage the user to perform a particular movement to cause a particular UI action to occur: in this non-limiting example, the message 504 encourages user to nod twice to validate a selected menu choice 506 from a graphic menu list 508.

FIG. 5B shows another exemplary screenshot 520, such that the user selected the “Total Recall” movie 522 using gaze aiming (this is the white circle or reticle 524); then the user can lean to the right, which, in accordance with preferred embodiments, can open a menu box 526 proposing new options (i.e., watch movie, share, and add to favorites). The system works well in graphically rich environments. However, where images captured by a sensor are uniform, substantially uniform, or lack enough distinct features, a movement analyzer can fail to properly track the movement. In that case, the system can present a user with feedback 528 indicating tracking difficulty.

FIG. 5C shows another exemplary screenshot 530, in which a message 532 appears to encourage the user to perform another, different movement to cause a particular UI action to occur: in this non-limiting example, the message 532 encourages the user to perform a quick headshake to cancel a selection 506.

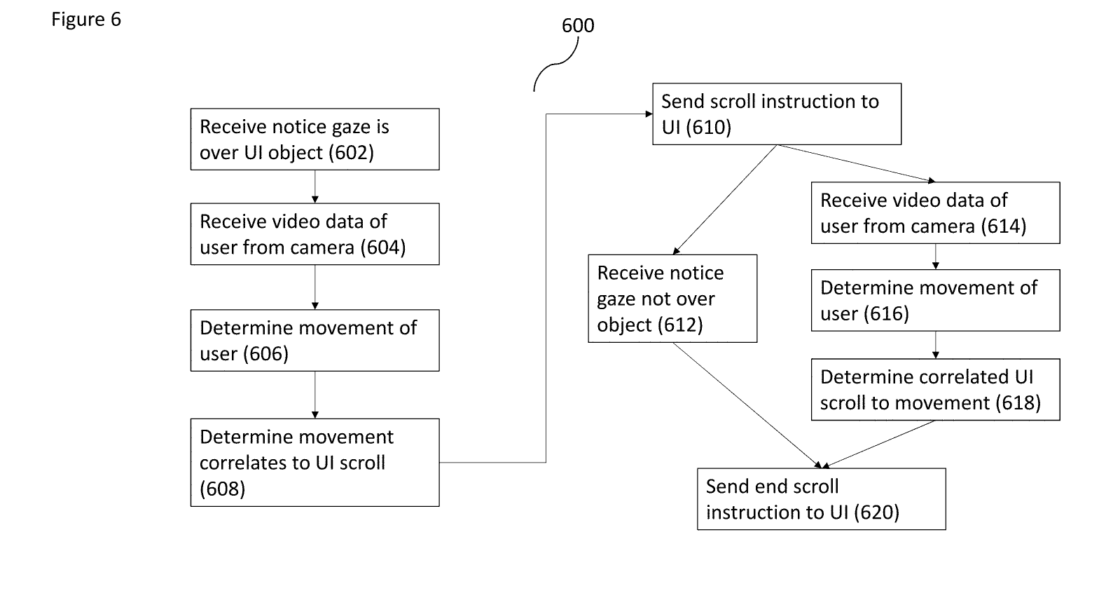

FIG. 6 illustrates an exemplary method 600 for combining classical gaze interaction with a fluid UI. At step 602, an event trigger notice that the user has selected a UI object through a gaze is received. At step 604, video data of the user is received from one or more cameras. At step 606, a movement of the user is determined using optical analysis of the image data from the camera(s). At step 608, a UI scroll interaction that correlates with the movement is determined. In this exemplary method, the UI object can be a list or series of other, secondary UI objects as in FIGS. 5A-5C and the scroll instruction can be to scroll through the list, either to the left or right depending on the lean. At step 610, an instruction to scroll through the UI object. In response to the instruction, the UI can move through list of secondary UI objects. At step 612, an event trigger notice that the user has moved the gaze off of the list UI object is received. In response, at step 620, an instruction to end the scrolling interaction is sent to the UI. In other words, the UI would stop moving through the list of secondary UI objects. As an alternative, at step 614, additional video data of the user can be received from the one or more cameras. At step 616, a movement of the user can be determined using optical analysis from that additional video data. At step 618, a UI instruction to cease scrolling that correlates to the movement is determined. In response, at step 620, the same instruction to end the scrolling interaction is sent to the UI.

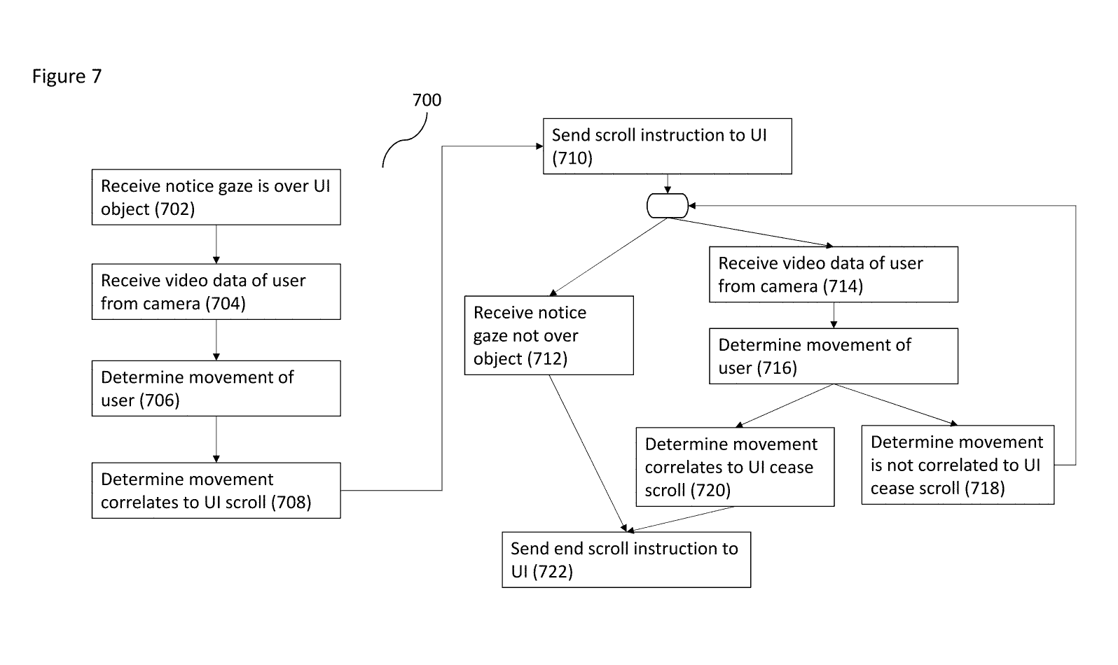

FIG. 7 illustrates another exemplary method 700 for combining classical gaze interaction with a fluid UI. At step 702, an event trigger notice that the user has selected a UI object through a gaze is received. At step 704, video data of the user is received from one or more cameras. At step 706, a movement of the user is determined using optical analysis of the image data from the camera(s). At step 708, a UI scroll interaction that correlates with the movement is determined. In this exemplary method, the UI object can be a list or series of other, secondary UI objects as in FIGS. 5A-5C and the scroll instruction can be to scroll through the list, either to the left or right depending on the lean. At step 710, an instruction to scroll through the UI object. In response to the instruction, the UI can move through list of secondary UI objects. At step 712, an event trigger notice that the user has moved the gaze off of the list UI object is received. In response, at step 722, an instruction to end the scrolling interaction is sent to the UI. In other words, the UI would stop moving through the list of secondary UI objects. As an alternative, at step 714, additional video data of the user can be received from the one or more cameras. At step 716, a movement of the user can be determined using optical analysis from that additional video data. At step 718, an optical analysis determines that the movement does not correlate to an instruction related to the current interaction. As a result, no instruction is sent to cease scrolling or take any other action and the scrolling continues. As an alternative, at step 720, a UI instruction to cease scrolling that correlates to the movement is determined. In response, at step 722, the same instruction to end the scrolling interaction is sent to the UI.

FIG. 8 illustrates a diagram of movements in two-dimensional space modulated with fuzzy logic to assist in creating a fluid UI. With fuzzy logic, an optical or other type of movement analysis will determine that an instruction for a UI function or interaction (e.g., moving a UI object) should be issued only if the movement moves beyond a boundary. Within the boundary, the movement will not result in a UI function or interaction. In this way, slight movements by the user will not accidentally trigger some UI function or interaction. In FIG. 8, movement 802 begins at a starting position between a left boundary and right boundary along a movement axis. Here, the user moves beyond the right boundary and consequently triggers a UI function or interaction. Movement 804 likewise shows the user moving beyond the left boundary to trigger a UI function or interaction. Movement 806, on the other hand, starts and ends within the boundary and consequently does not result in an instruction for a UI function or interaction being sent.

The boundary thresholds could be determined based on the user's age, size, or some other physical characteristics. In some embodiments, a boundary threshold could be set through calibration by the user. For example, the user can hold one or more static poses and communicate to the system when the user was holding the static pose, when the user had completed the static pose, or both. For example, the user can issue an audible command or select an option on a calibration interface to begin or end a calibration exercise. The system could record movement data and generate a value indicating the distance from boundary to boundary from the movement data. Additionally, multiple fuzzy logic boundaries can be calibrated depending on the type of movement. Larger movements can be associated with larger boundary distances and smaller movements can be associated with smaller boundary distances. For example, in some embodiments, a movement error of 2 cm can be used for a lean gesture. That is, after the user has completed the movement of the lean and is holding the lean to maintain the UI activity, the user can move 2 cm in any direction and maintain the UI activity (e.g., list scroll) without disruption to or change in the UI activity. A static pose for an arm gesture, a gesture more easily controlled by most users, can have an error value of 1.5 cm and a static pose for a hand, even more controllable, can have an error value of 1 cm. In some embodiments, a default value can be used before or in place of calibration or receipt of user-specific data.

FIG. 9 illustrates an exemplary method 900 for creating a more fluid UI by applying an error to flow vectors to set a position of a UI object to correspond with movement of the user. At step 902, a raw position of a UI object is determined from one or more flow vectors generated from a movement analysis or some other indicator of position. The raw position is the position the UI object would be within the UI based on the movement of the user without any modulation. The UI object were to be displayed using the raw position, all the jitter resulting from user movement would be apparent in the UI. At step 904, the error correction value is applied to the raw position using linear interpolation. That is, the error correction value is added to the value of the raw position of the UI object as determined from the movement analysis along a line that also runs through a value of the current position of the UI object. Thus, by determining a position that has a value along the line, a more fluid UI movement is visible. At step 906, a flow vector for a new movement is determined through movement analysis. At step 908, it is determined whether to calculate a new error correction value. The calculation preferably is not done at every iteration of movement. In preferred embodiment, the calculation can occur two times per second. In some embodiments, either or both of the error correction value and the determination of when to calculate a new error correction value can be based on the speed of the user movement. That is, if the user is moving more quickly the error value can be higher or can be done less frequently. At step 910, the new error correction value is calculated. For example, if the user movement was slowing, the error value can be slightly reduced from period to period until the error value is calculated again, such that a recalculation may be based on the speed of the user. In some embodiments, a value between −1 and 1 can be computed as the error value. Whether the number is positive or negative can depend on whether the position moves to one side or another from a base position along an axis.

Any and all references to publications or other documents, including but not limited to, patents, patent applications, articles, webpages, books, etc., presented in the present application, are herein incorporated by reference in their entirety.

Example embodiments of the devices, systems and methods have been described herein. As noted elsewhere, these embodiments have been described for illustrative purposes only and are not limiting. Other embodiments are possible and are covered by the disclosure, which will be apparent from the teachings contained herein. Thus, the breadth and scope of the disclosure should not be limited by any of the above-described embodiments but should be defined only in accordance with claims supported by the present disclosure and their equivalents. Moreover, embodiments of the subject disclosure may include methods, systems and apparatuses which may further include any and all elements from any other disclosed methods, systems, and apparatuses, including any and all elements corresponding to target particle separation, focusing/concentration. In other words, elements from one or another disclosed embodiment may be interchangeable with elements from other disclosed embodiments. In addition, one or more features/elements of disclosed embodiments may be removed and still result in patentable subject matter (and thus, resulting in yet more embodiments of the subject disclosure). Correspondingly, some embodiments of the present disclosure may be patentably distinct from one and/or another reference by specifically lacking one or more elements/features. In other words, claims to certain embodiments may contain negative limitation to specifically exclude one or more elements/features resulting in embodiments which are patentably distinct from the prior art which include such features/elements.

What is claimed is:

1. A method for providing a fluid UI (user interface) for a virtual or mixed reality environment, comprising:
receiving a first signal including sensor data generated by a sensor for a first movement by a user;
analyzing, using an optical analyzer, the sensor data for the first movement to compute an at least one flow vector for the first movement;
determining, from the at least one flow vector, the first movement;
correlating the first movement to a UI instruction, the UI instruction comprising an instruction to select a UI object.

2. The method of claim 1, wherein at least a portion of the sensor data is generated by a camera and comprises image data.

3. The method of claim 2, wherein the camera is mounted to the body of the user and the image data comprises an image of an environment of the user.

4. The method of claim 2, further comprising:
generating, using a mapping processor, a map of a user environment and wherein the analyzing the sensor data includes comparing image data of a user against image data from the map of the user environment.

5. The method of claim 2, further comprising:
reducing the image data using a Gaussian pyramid.

6. The method of claim 5 wherein the Gaussian pyramid includes 2 to 3 levels.

7. The method of claim 2, wherein the analyzing the sensor data includes applying at least one algorithm selected from the group consisting of: a differential method for optical flow estimation, phase correlation, block-based method for optical flow estimation, discrete optimization methods, simultaneous localization and mapping (SLAM), and a 6 DOF (degrees of freedom) algorithm.

8. The method of claim 7, wherein the differential method for optical flow is selected from the group consisting of the Lucas-Kanade method, the Horn-Schunck method, the Buxton-Buxton method, and the Black-Jepson method.

9. A method for providing a fluid UI (user interface) for a virtual or mixed reality environment, comprising:
receiving a first signal including sensor data generated by a sensor for a first movement by a user;
analyzing, using an optical analyzer, the sensor data for the first movement to compute an at least one flow vector for the first movement;
determining, from the at least one flow vector, the first movement;
correlating the first movement to a UI instruction, the UI instruction comprising an instruction to scroll a UI object.

10. The method of claim 9, further comprising:
receiving a second signal including sensor data generated by a sensor for a second movement by a user;
analyzing, using an optical analyzer, the sensor data for the second movement to compute an at least one flow vector for the second movement;
determining, from the at least one flow vector, the second movement;
correlating the second movement to a UI instruction, the UI instruction comprising an instruction to cease scrolling the UI object.

11. The method of claim 9, further comprising:
receiving a second signal comprising an event notification that a gaze has moved off the UI object;
sending, in response to the event notification, a second UI instruction comprising an instruction to cease scrolling the UI object.

12. A system for providing a fluid UI (user interface) for a virtual environment, comprising:
a display for displaying information to a user;
a sensor for recording image data about a movement of the user; and
a movement analyzer configured to receive the image data and to compute an at least one flow vector from the image date and to determine a movement from the at least one flow vector;
a UI mapper configured to correlate the movement to a UI instruction comprising an instruction to select a UI object.

13. The system of claim 12, further comprising a sensor for capturing inertial data about a movement of a user and wherein the movement analyzer is configured to compute the at least one flow vector from the image data and the inertial data.

14. The system of claim 13, wherein the sensor for capturing inertial data comprises one or more of an accelerometer, a gyroscope, and a magnetometer.

15. The system of claim 12, wherein the sensor comprises one or more of an RGB, color, grayscale or infrared camera, a charged coupled device (CCD), a CMOS sensor, and a depth sensor.

16. The system of claim 12, wherein the movement analyzer is configured to compute the at least one flow vector using at least one algorithm selected from the group consisting of: a differential method for optical flow estimation, phase correlation, a block-based method for optical flow estimation, a discrete optimization method, simultaneous localization and mapping (SLAM), and a 6 DOF (degrees of freedom) algorithm.

17. The system of claim 16, wherein the differential method for optical flow estimation is selected from the group consisting of: the Lucas-Kanade method, the Horn-Schunck method, the Buxton-Buxton method, and the Black-Jepson method.

18. The system of claim 12, further comprising a camera calibrator configured to calibrate a plurality of cameras.

19. The system of claim 13, wherein at least one of the sensor for capturing image data and the sensor for capturing inertial data is in physical communication with a body part of the user.

20. The system of claim 19, further comprising a wearable device and wherein the at least one of the sensor for capturing image data and the sensor for capturing inertial data is in physical communication with the wearable device.

21. The system of claim 20, wherein the wearable device comprises a mobile computational device and the at least one of the sensor for capturing image data and the sensor for capturing inertial data is a component of the mobile device.
